(19) United States
(12) Patent Application Publication
(10) Pub. No.: US 2002/0143911 A1
(43) Pub. Date: Oct. 3, 2002

(54) Host-based network traffic control system

(76) Inventors: John Vicente, Roseville, CA (US); Lilin X. Xie, Folsom, CA (US); Harold L. Cartmill, Rancho Cordova, CA (US)

Correspondence Address: PILLSBURY WINTHROP, LLP, P.O. BOX 10500, MCLEAN, VA, 22102, US

(21) Appl. No.: 09/820,817

(22) Filed: Mar. 30, 2001

(51) Int. Cl. G06F 15/173

(52) U.S. Cl. 709/223; 709/224

(57) ABSTRACT

An arrangement is provided for host-based Quality of Service (QoS) provisioning. A host system initiates data flows that are sent to a network. A centralized QoS provisioning mechanism is described that connects to the host system and enforces flow control on the data flows originated from the host system before they are sent to the network.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to network management. Other aspects of the present invention relate to Quality of Service (QoS) flow control.

In our information age, achieving the highest network service quality is as important as developing best class of networking products. This is particularly so when new applications, such as voice over Internet Protocol (VOIP) and video conferencing, place new demands on the network. Various network management approaches, network protocols, and standards have been proposed, aiming at improving the network management efficiency and maximizing the utilization of the network.

Quality of Service (QoS) mechanisms are proposed to provide the necessary level of service to applications and to maintain an expected quality level. Applications may be classified into different levels of service based on certain criteria or policies (e.g., priority) and each level of service is treated according to the classification. Based on QoS policies, different kinds of flows can be QoS enabled and network resources can then be allocated according to the specified QoS and the associated policies. Some current applications are being developed with QoS features enabled so that the data flows generated by such applications can be properly managed or policed when they are transmitted over networks.

However, many existing applications are not QoS enabled. A large portion of these are legacy-based applications. Some applications may be developed without QoS capabilities because of the cost associated with hiring skilled personnel to implement QoS enabled systems. As a result, the traffic generated by such applications may not be properly QoS verified prior to and after being transmitted over networks.

Currently, a data flow initiated from an application is flow controlled independently by the application or supporting transport services, but it may not be appropriately QoS verified or policed prior to entering the network. Thus, aggregate data flows initiated by multiple applications from a common access network, such as a Local Area Network (LAN) may behave chaotically, leading to unforeseen problems.

### BRIEF DESCRIPTION OF THE DRAWINGS

The present invention is further described in terms of exemplary embodiments which will be described in detail with reference to the drawings. These embodiments are non-limiting exemplary embodiments, in which like reference numerals represent similar parts throughout the several views of the drawings, and wherein:

FIG. 1 is a block diagram of one embodiment of the present invention, in which data flows initiated from a host system are managed by a centralized QoS provisioning mechanism;

FIG. 2 illustrates the structure of a host system in relation to the structure of a centralized QoS provisioning mechanism;

FIG. 3 illustrates a high level block diagram of one embodiment of the present invention, in which a network traffic control administrator collaborates with a plurality of network traffic control agents to achieve centralized QoS provisioning on a host system;

FIG. 4 is an exemplary flowchart for centralized QoS provisioning mechanism;

FIG. 5 is an exemplary flowchart for feedback-driven QoS provisioning;

FIG. 6 is a block diagram for a network traffic control agent, in relation to a client on which the agent resides;

FIG. 7 is an exemplary processing flowchart for a network traffic control agent;

FIG. 8 is a block diagram for a network traffic control administrator, in relation to other parts in a centralized QoS provisioning mechanism;

FIG. 9 is a flowchart for a process, in which initial centralized QoS provisioning is performed;

FIG. 10 is a flowchart for a process, in which per-flow information and network performance information are used to generate corresponding statistics;

FIG. 11 is a block diagram of a QoS provisioning policy updating unit, in relation to other components in a centralized QoS provisioning mechanism;

FIG. 12 illustrates different processes, in which QoS provisioning policies may be updated in manual user-driven mode, automatic feedback-driven mode with either a long cycle or a short cycle; and

FIG. 13 is an exemplary flowchart for updating QoS provisioning policies.

### DETAILED DESCRIPTION

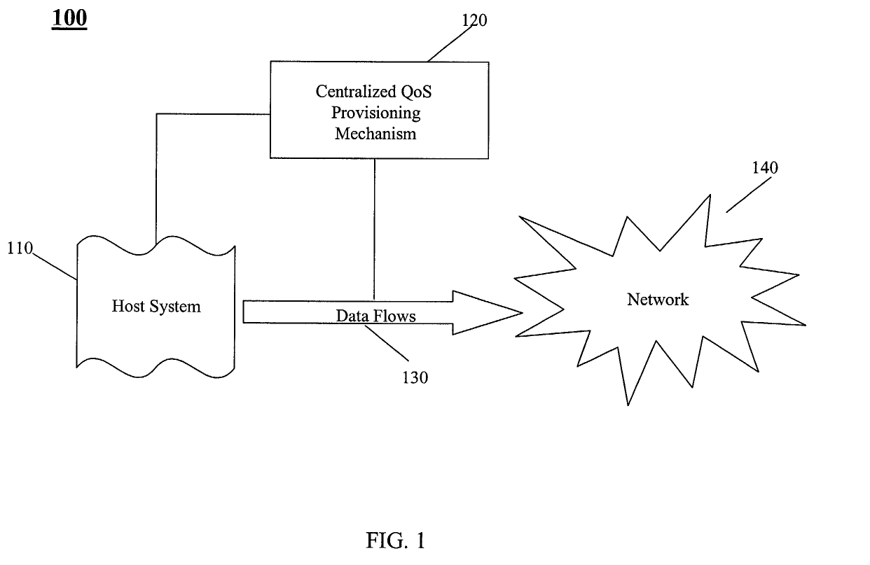

FIG. 1 is a block diagram of one embodiment of the present invention, in which a host-based network traffic control system 100 is shown. The system 100, as illustrated in FIG. 1, comprises a host system 110, a centralized QoS provisioning mechanism 120, data flows 130, and a network 140. In the host-based network traffic control system 100, the host system 110 generates the data flows 130 to be sent to the network 140. The data flows 130, when sent to the network 140, is controlled and managed by the centralized QoS provisioning mechanism 120.

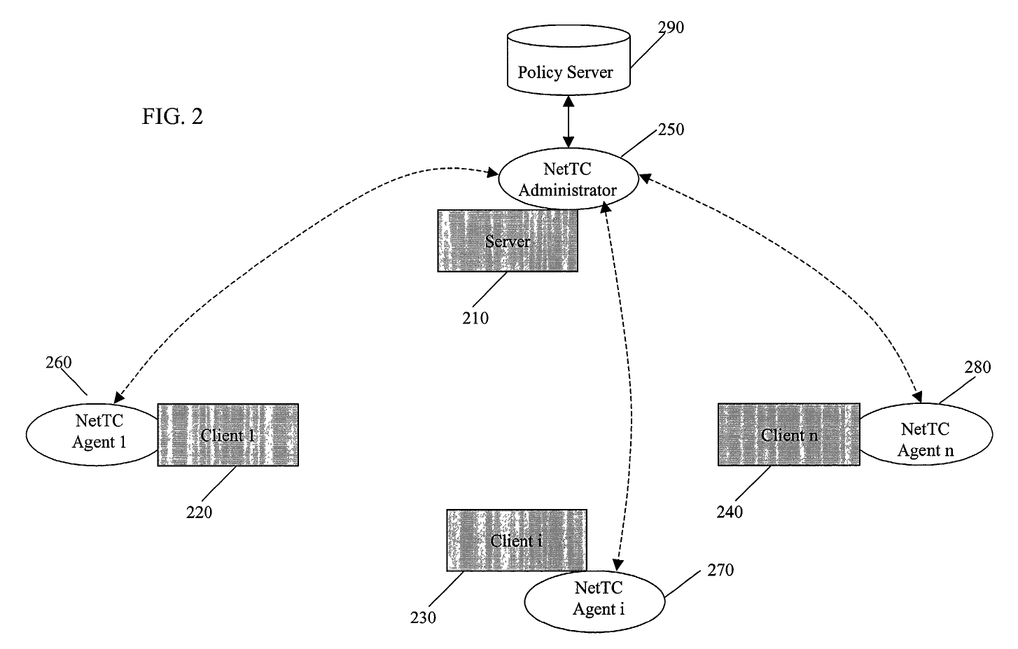

The host system 110 may represent a general local distributed system. For example, the host system 100 may correspond to a Local Area Network (LAN) in an office building. The host system 100 may also comprise all the computer systems in a proprietary network of an organization (e.g., a corporation), where those computer systems may be physically distributed in different geographic regions. FIG. 2 shows, in part, an exemplary host system 110, which comprises a server 210 and a plurality of client, client 1 220, . . . , client i 230, . . . , client 240. Each client in FIG. 2 may be capable of independently communicating with the server 210. All the components in the exemplary host system 110 shown in FIG. 2, including the server 210 and the clients 220, . . . ,230, . . . ,240, are connected to the network 140 and capable of sending data flows to the network 140.

The centralized QoS provisioning mechanism 120 may also be a distributed system. An exemplary configuration of the centralized QoS provisioning mechanism 120 is shown in FIG. 2, in which the centralized QoS provisioning mechanism 120 comprises, in part, a Network Traffic Control administrator (NetTC administrator) 250 and a plurality of Network Traffic Control agent (NetTC agent) 260, . . . ,270, . . . ,280 where the NetTC administrator 250 is installed and running on the server 210 and the NetTC agents 260, . . . ,270, . . . ,280 are installed and running on the clients 220, . . . ,230, . . . ,240, respectively.

The QoS provisioning may be initially performed, in a centralized fashion, by the NetTC administrator 250. The QoS flow control is then enforced via NetTC agents in a distributed fashion. Each NetTC agent (e.g., NetTC agent 1 260) may be responsible for enforcing QoS flow control on data flows generated by the client (e.g., client 1 220) on which the NetTC agent (260) resides. NetTC agents 260, . . . ,270, . . . ,280 communicate with the NetTC administrator 250 and together they achieve host-based network traffic control.

In FIG. 2, the NetTC administrator 250 performs centralized QoS provisioning to generate QoS policies. The generated QoS policies may be stored on a policy server 290, which can then be accessed, retrieved, and updated. For example, in one embodiment of the present invention as described in FIG. 2, the NetTC administrator 250 may write QoS policies to the policy server 290 and may dynamically later update existing QoS policies that are already stored in the policy server 290.

The data flows 130, shown in FIG. 1, may represent general data streams that, when sent to the network 140, generate network traffic. The network 140, as shown in FIG. 1 as a cloud, may represent a generic type of communication network. For example, the network 140 may represent the Internet. The network 140 may also represent any proprietary network.

The data flows 130 may be generated by applications running in the host system 110. For example, an electronic mail message initiated from a client in the host system 110 and sent to a destination via the network 140 is a data flow, which may be generated by an Internet mailer application. As another example, a video stream corresponding to a video conference session may be captured live by a video conferencing application in the host system 110 and may be sent, as a data flow, to a different site of the same video conference session via the network 140.

A data flow may require certain network service class types while being transmitted through the network 140. Depending on the data flow, the types of network service classes required and the amount of network resource for each required type may differ. For example, the data flow generated by an Internet mailer application from an electronic mail message may require an insignificant amount of bandwidth. Alternatively, the data flow generated by a video conferencing application during a live video conference session may require guaranteed and uninterrupted high bandwidth.

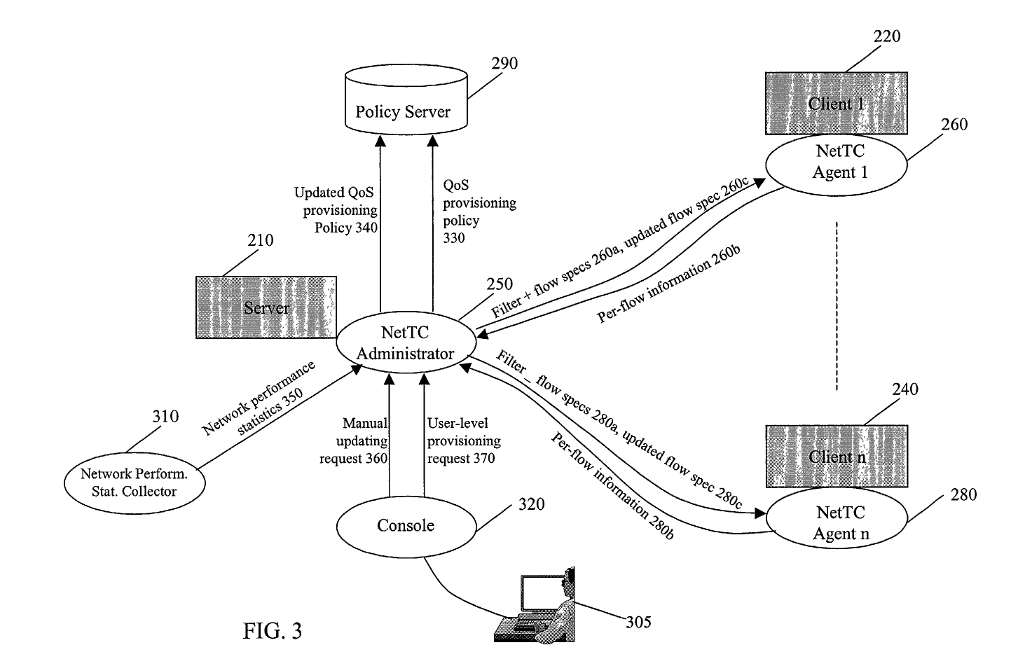

In QoS flow control, data flows may be sent to the network 140 with their packets marked according to flow specifications. In the host-based network traffic control system 100, the flow specification associated with a data flow is constructed by the NetTC administrator 250 based on QoS provisioning policies. The flow control is then enforced through the NetTC agent running on the client where the application that generates the data flow is installed and running. This may be achieved by sending the flow specification, constructed centrally by the NetTC administrator 250, to the relevant NetTC agent(s) so that the flow specification may be applied to the data flow, at the client site, whenever the application that generates the data flow is running. This process is shown in more detail in FIG. 3.

In FIG. 3, the centralized QoS provisioning mechanism 120 comprises a NetTC administrator 250, a plurality of NetTC agents 260, . . . ,270, . . . ,280, a policy server 290, a network performance statistics collector 310, and a console 320. The NetTC administrator 250 is installed and running on the server 210. NetTC agents (260, . . . ,280) are installed and running on corresponding clients (220, . . . ,240). Each NetTC agent is responsible for enforcing the flow control on the data flows generated from the applications running on the client where the NetTC agent resides. The NetTC administrator 250 is responsible for centralized QoS provisioning and for remotely controlling the enforcement of flow control on the data flows generated by the host system 110, via the NetTC agents associated with the clients 220, . . . ,240.

A QoS provisioning policy may be initially established by the NetTC administrator 250 through a manual process or a user-level provisioning process via a console 320. Initial establishment of a QoS provisioning policy associated with an application may be carried out when the application is installed in the host system 110 (on any of the server 210 and clients 220, . . . ,240). The manual QoS provisioning process may be requested by a human administrator 305 by sending a user-level provisioning request 370 via the console 320. During the user-level provisioning, the human administrator 305 may specify QoS provisioning policy for the application via the console 320 and send the specified QoS policy to the NetTC administrator 250. The NetTC administrator 250 receives the QoS provisioning policy corresponding to the application and stores such initial QoS provisioning policy 330 in the policy server 290.

When the initial QoS provisioning policy 330 is generated, the NetTC administrator 250 also constructs accordingly a filter and a flow specification (e.g., 260a) associated with the application based on the QoS provisioning policy 330. The constructed filter and flow specification are sent to the NetTC agent that resides on the client where the application is installed or running.

The NetTC agent uses the filter and the flow specification to enforce flow control on the data flow generated by the application. Specifically, the filter may be used by the NetTC agent to identify the application when it is activated (or running) and the data flow is made QoS enabled according to the flow specification. That is, the packets of the data flow generated by the running application can then be marked, rate or priority scheduled based on the flow specification and corresponding QoS policy.

The initial QoS provisioning policies stored in the policy server 290 may later be updated. The centralized QoS provisioning mechanism 120 illustrated in FIG. 1 may support both manual user-driven provisioning policy updating and automatic feedback-driven provisioning policy adaptation. To perform manual provisioning policy update, the human administrator 305 sends a manual update request 360 to the NetTC administrator 250 via the console 320. The update measures may then be specified by the human administrator 305 on the console 320 and sent to the NetTC administrator 250. The NetTC administrator 250 receives the update measures and subsequently revises the corresponding and existing QoS provisioning policies. The revision yields updated provisioning policy 340 which is then sent to the policy server 290.

In the automatic feedback-driven adaptation mode, the NetTC administrator 250 may automatically determine how the QoS policies should be adjusted based on various system feedback statistics. Such feedback statistics may be computed based on observations made, for example, on the network wide usage as well as the performance on individual data flows. In FIG. 3, NetTC agents 260, . . . ,280 may monitor data flows generated by clients 220, . . . ,240 and collect per flow information 260a, . . . ,280a. The NetTC administrator 250 may explicitly instruct NetTC agents what type of information to collect from flows. The collected per flow information 260a, . . . ,280a is sent back to the NetTC administrator 250 where various per flow usage statistics may be computed dynamically.

A network performance statistics collector 310 monitors the local network of the host system 110 and collects information related to various aspects of the network usage and performance. The NetTC administrator 250 may also explicitly instruct the network performance statistics collector 310 what type of network performance statistics to collect. Such network performance statistics 350 are then sent back to the NetTC administrator 250 where various local network usage statistics may be further derived.

Additionally, per flow usage statistics, computed by the NetTC administrator 250 based on the per flow information 260a, . . . ,280a, constitute the feedback about the data flows 130 that are controlled according to the current QoS provisioning policies (stored in the policy server 290). Local network usage statistics, derived by the NetTC administrator 250 based on the network performance statistics 350 provide a global picture about the local network usage imposed on the host system 110 and its traffic. Based on these dynamically derived (feedback) statistics, the NetTC administrator 250 may automatically determine the adaptation strategies or adaptation measures to be used to revise existing QoS provisioning policies so that the network usage and the flow control may be optimized. The adaptation process generates updated QoS provisioning policy 340 which is then sent to the policy server 290.

The automatic feedback-driven provisioning policy adaptation may be conducted regularly according to certain periodicity. Different periodicity may be employed simultaneously so that a plurality of threads of automatic feedback-driven provisioning policy adaptation may be running concurrently. In this case, each of the threads may cycle according to a different periodicity. The length of each cycle maybe designed according to specific criteria to fit the needs of underlying applications. In each thread, depending on the cycle length, different statistics may be adopted in devising corresponding adaptation strategies.

Feedback statistics may also be used in a manual user-driven policy updating process. The human administrator 305 may first review and examine different performance related statistics before devising corresponding update measures.

When a QoS provisioning policy is revised, through either a manual process or an automatic process, the NetTC administrator 250 re-constructs an updated flow specification (e.g., 260c) according to the updated QoS provisioning policy 340 and sends the updated flow specification to the NetTC agent (e.g., 260) that holds the original flow specification (e.g., 260a). With the updated flow specification 260c, the NetTC agent 260 can enforce the flow control that is consistent with the updated QoS provisioning policy 340.

In FIG. 3, the policy server 290 may reside on the server 210, together with the NetTC administrator 250. It may also reside on a different physical computer. Similarly, the network statistics collector 310 may reside on the server 210, together with the NetTC administrator 250. It may also reside on a different physical computer in the host system 110.

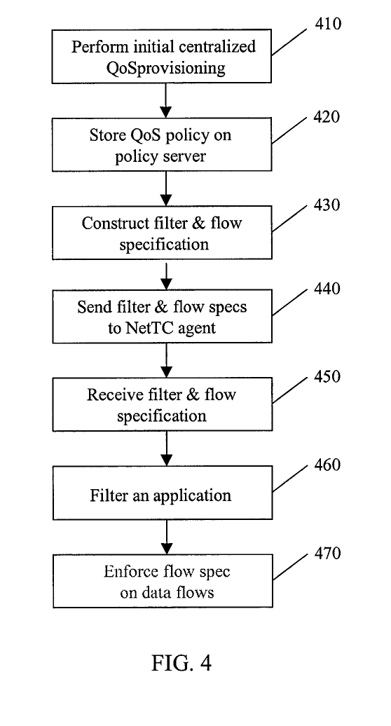

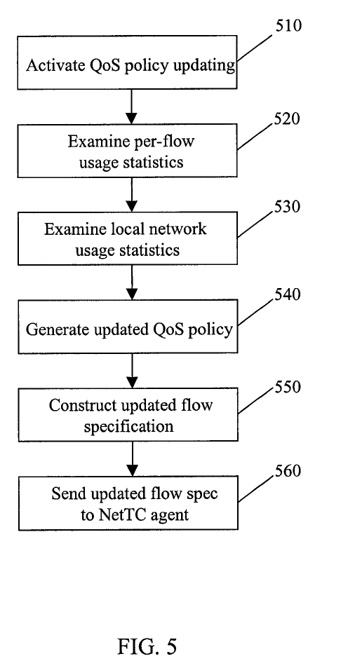

FIG. 4 and FIG. 5 describe the flow in the centralized QoS provisioning mechanism 120. FIG. 4 is the flowchart for initial QoS provisioning and QoS flow control. An initial centralized QoS provisioning with respect to an application is first performed at act 410. The QoS provisioning policy generated during the initial provisioning process is then stored, at act 420, in the policy server 290. Based on the initial QoS policy, the NetTC administrator 250 constructs, at act 430, a filter and a flow specification. Such filter and flow specification are then sent, at act 440, to a NetTC agent (that resides on the same client where the application is installed) and received by the NetTC agent at act 450. The NetTC agent filters the application at act 460 using the filter received and enforces, at act 470, flow control on the data flows generated by the application based on the received flow specification.

FIG. 5 is an exemplary flowchart for the process of revising an existing QoS provisioning policy. The QoS policy updating process is first activated at act 510. The activation may be automatic or manual. Once activated, per flow usage statistics are examined at act 520 and local network usage statistics are examined at act 530. Based on these feedback statistics, an updated QoS provisioning policy is generated at act 540. Subsequently, the updated QoS policy may be sent to the policy server 290 to replace the previous QoS policy (not shown in FIG. 5). To replace the flow specification installed previously on a corresponding NetTC agent, an updated flow specification is constructed, at act 550, according to the updated QoS policy and sent, at act 560, to the corresponding NetTC agent.

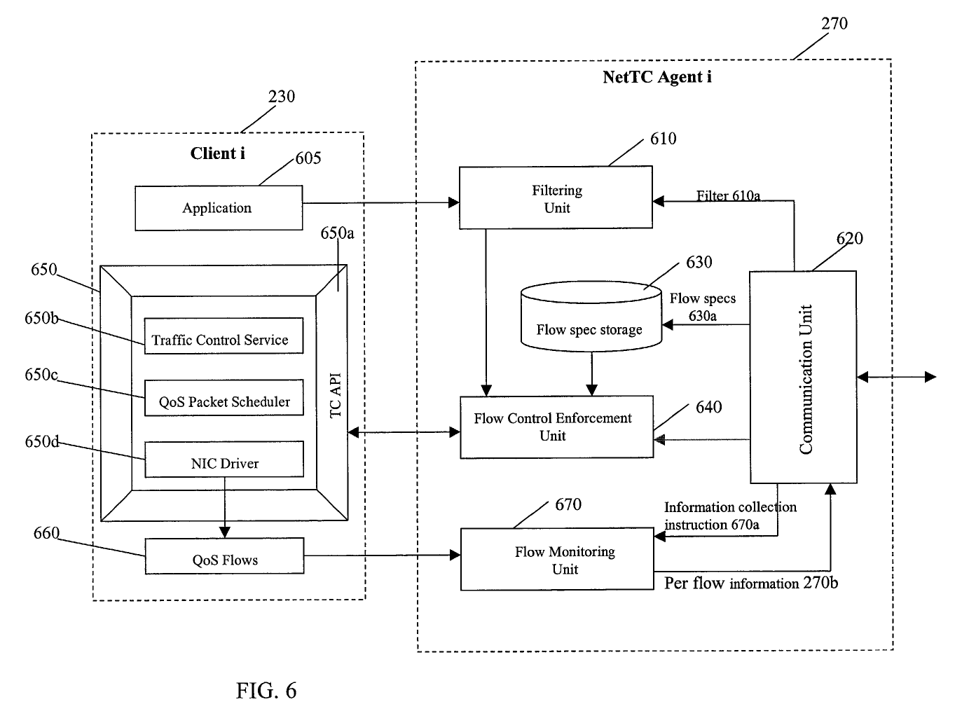

In the host-based network traffic control system 100 (FIG. 3), the NetTC administrator 250 performs QoS provisioning to generate QoS policies in a centralized fashion. The NetTC agents 260, . . . ,280 enforce the QoS policies through filters and flow specifications in a distributed fashion. FIG. 6 shows a block diagram of a NetTC agent (e.g., NetTC agent i 270), in relation to its associated client (e.g., client i 230). In FIG. 6, the NetTC agent 270 comprises a communication unit 620, a filtering unit 610, a flow specification storage 630, a flow control enforcement unit 640, and a flow monitoring unit 670. The communication unit 620 enables the communication between the NetTC agent 270 and the NetTC administrator 250. For example, through the communication unit 620, the NetTC agent 270 may receive a filter 610a and its corresponding flow specification 630a from the NetTC administrator 250.

The received filter 610a is constructed (by the NetTC administrator 250) with respect to an application (e.g., 605) installed on the client 230 on which the NetTC agent 270 resides. The flow specification 630a is constructed (by the NetTC administrator 250) based on the QoS policy associated with the data flow generated by the application 605. The received flow specification 630a may made active or can be stored in the flow specification storage 630. The flow specification 630a may be retrieved from the storage 630 and applied to a data flow for flow control, as needed.

The filtering unit 610 in FIG. 6 filters an application using a filter (e.g., filter 610a). The filter may be constructed by the NetTC administrator 250 when the initial QoS provisioning associated with the application is performed. The flow control enforcement unit 640 enforces flow control on the data flows generated by an application (e.g., application 605). The flow control is achieved through a flow specification (e.g., flow specification 630a). When the flow control enforcement unit 640 is informed of a running application (e.g., 605), it retrieves the corresponding flow specification (630a) and enforces flow control on the data flows generated by the application (605) to generate QoS enabled flows 660.

The flow control enforcement unit 630 may interface with a Traffic Control Application Programming Interface (TC API) to manage flows. For example, a NetTC agent may use the QoS TC API (650a) made available through Microsoft product Windows 2000 (650) to manage flows. The flows are controlled and managed according to flow specifications retrieved from the flow specification storage 630 or via the communication unit 620. This is illustrated in FIG. 6. Through the TC API 650a, the flow control enforcement unit 640 may utilize various components of the QoS TC API of the Windows 2000 (650) to execute flow control. Examples of such components may include the traffic control service 650b, the QoS packet scheduler 650c, and the NIC driver 650d to generate QoS flows 660.

To facilitate feedback-driven QoS policy updating, a NetTC agent collaborates with the NetTC administrator 250 and monitors the QoS flows 660 to collect per flow information. This is performed by the flow monitoring unit 670. The NetTC administrator 250 may send NetTC agents information collection instruction 670a specifying what per flow information to monitor and to collect. Upon receiving the instruction 670a, the flow monitoring unit 670 collects requested per flow information 270b from QoS flows 660 and sends the collected per flow information 270b back to the NetTC administrator 250 via the communication unit 620.

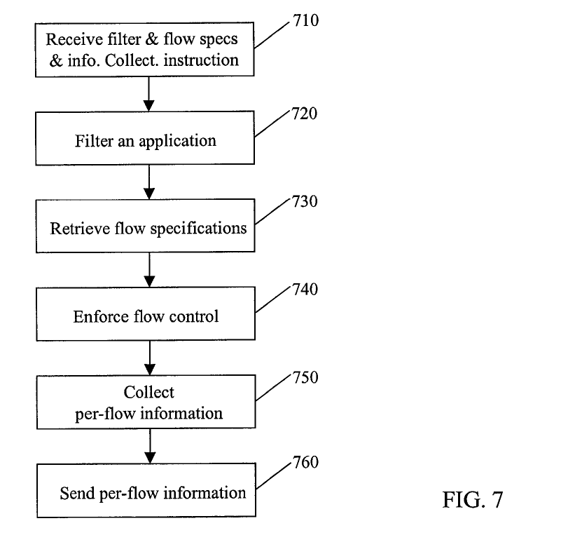

FIG. 7 is a flowchart for a NetTC agent. At act 710, a filter, its corresponding flow specification (both are associated with an application), and the information collection instruction 670a are received from the NetTC administrator 250. Based on the received filter, the associated application is filtered at act 720. The corresponding flow specification is then retrieved, at act 730. The flow control on the data flows generated by the filtered application is enforced at act 740 using the retrieved flow specifications. The flow control yields QoS flows 660. Based on the information collection instruction 670a, corresponding per flow information, requested by the NetTC administrator 250 via the information collection instruction, is collected at act 750 and sent to the NetTC administrator 250 at act 760.

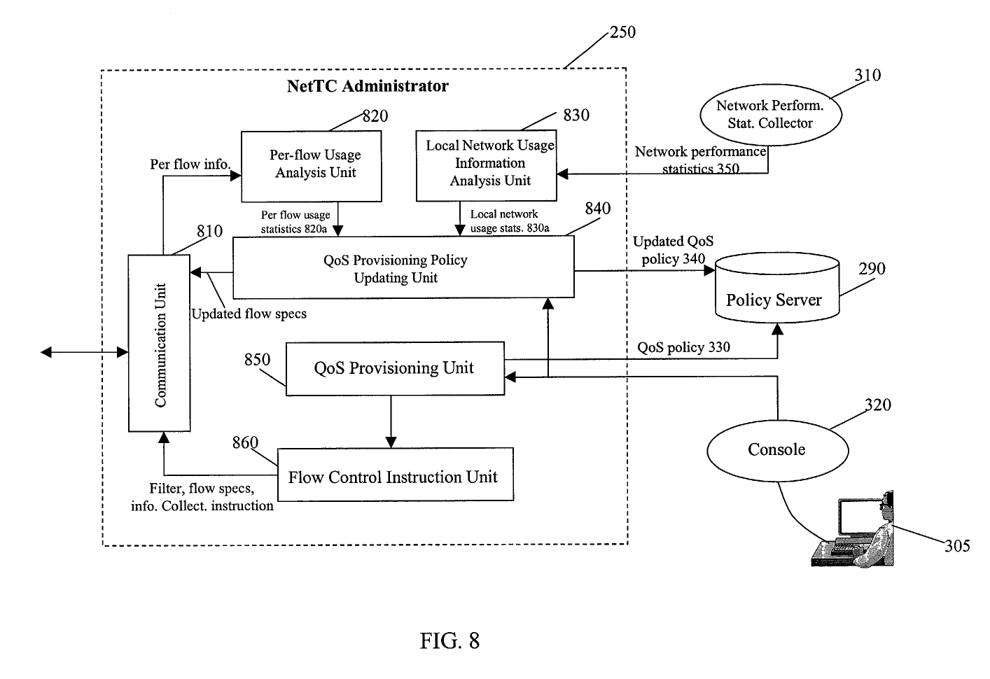

FIG. 8 shows a block diagram of the NetTC administrator 250, in relation to other parts of the centralized QoS provisioning mechanism 120. In FIG. 8, the NetTC administrator 250 comprises a communication unit 810, a per flow usage analysis unit 820, a local network usage information analysis unit 830, a QoS provisioning policy updating unit 840, a QoS provisioning unit 850, and a flow control instruction unit 860. The communication unit 810 facilitates the communication between the NetTC administrator 250 and the distributed NetTC agents 260, . . . ,270, . . . ,280. For example, the NetTC administrator 250 may send information collection instructions to various NetTC agents via the communication unit 810. The NetTC agents may also send per flow information collected from the QoS flows initiated on different clients to the NetTC administrator 250 via the communication unit 810.

The QoS provisioning unit 850 performs centralized QoS provisioning to initially establish QoS policies. The QoS provisioning unit 850 may interact with the human administrator 305 via the console 320. The QoS policies established during the QoS provisioning process are stored on the policy server 290 and may later be updated by the QoS provisioning policy updating unit 840.

Based on the QoS policies initially established by the QoS provisioning unit 850, the flow control instruction unit 860 constructs corresponding filters and flow specifications. The constructed filters and flow specifications are then sent to relevant NetTC agents via the communication unit 810. In addition, the flow control instruction unit 860 may also generate and send collection instructions to the NetTC agents to instruct them on specific flow information to monitor and to collect.

The QoS policies established by the QoS provisioning unit 850 are enforced by NetTC agents at client sites using the filters and flow specifications constructed by and sent from the flow control instruction unit 860. The NetTC agents may also collect per flow information, per collection instructions sent from the flow control instruction unit 860, and sends the flow information back to the NetTC administrator 250.

The per flow information sent from the NetTC agents are received by the per flow usage analysis unit 820, via the communication unit 810. Such information may be analyzed by the per flow usage analysis unit 820 to derive various per flow usage statistics 820a. The statistics may provide useful information, with respect to individual flows, to the QoS provisioning policy updating unit 840 and may be used as a basis to devise QoS policy adaptation strategies.

The QoS provisioning policy updating unit 840 may also gather information from the local network usage information analysis unit 830. The local network usage information analysis unit 830 takes input from the network performance statistics collector 310 (the network performance statistics 350) and derive various local network usage statistics 830a. The network performance statistics collector 310 monitors the network traffic across the local network supporting the host system 110. The network performance statistics 350 provide useful information enabling the local network usage information analysis unit 830 to obtain a global picture about the network usage imposed on the host system 110.

After QoS provisioning policies are initially established, they may be updated periodically based on operational status from the host system 110. This is achieved by the QoS provisioning policy updating unit 840. As discussed earlier, QoS policy updating may be accomplished in either a manual, user-driven mode or an automatic, feedback-driven mode. The QoS provisioning policy updating unit 840 shown in FIG. 8 may facilitate both modes of updating.

The manual, user-driven QoS policy updating may be invoked by the human administrator 305 via the console 320. The human administrator 305 may also provide specific policy updating measures from the console 320. Such measures may be determined by the human administrator 305 based on the per flow usage statistics 820a and the local network usage statistics 830a. Based on the manual provided updating measures (made by the human administrator 305), the QoS provisioning policy updating unit may generate the update QoS provisioning policy 340 and store the update policy 340 in the policy server 290. In addition, the QoS provisioning policy updating unit 840 may also construct updated flow specification (e.g., 270c) according to the updated provisioning policy 340. Such updated flow specification (e.g., 270c) may then be sent to a corresponding NetTC agent (e.g., 270) via the communication unit 810.

The automatic feedback-driven QoS policy adaptation may be invoked internally according to certain periodicity. Once invoked, the QoS provisioning policy updating unit 840 may automatically determine the adaptation measures based on the per flow usage statistics 820a and the local network usage statistics 830a. Such adaptation measures are used to revise QoS provisioning policy to generate updated QoS provisioning policy 340. Similarly, the update QoS provisioning policy 340 is stored in the policy server 290 and corresponding updated flow specification (e.g., 270c) is constructed and sent to the corresponding NetTC agent (e.g., 270).

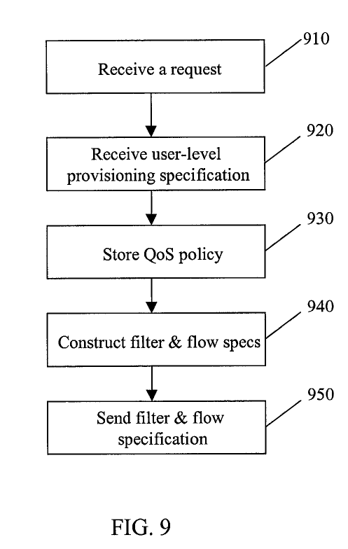

In the illustrated embodiment of the present invention, shown in FIG. 8, the NetTC administrator 250 performs different functions. A first function is to initially set up QoS provisioning policies for applications. A second function is to update existing QoS provisioning policies. The NetTC administrator 250 bridges these two functions by utilizing the feedback information (e.g., per flow information and network performance information) collected continuously from the running host system 110. FIG. 9 shows a flowchart of a process, in which the first function of the NetTC administrator is achieved.

In FIG. 9, the NetTC administrator 250 first receives, at act 910, a user-level provisioning request 370 for establishing QoS policy for an application. The human administrator 305 may provide a user-level provisioning policy specification and send it to the NetTC administrator 250. When the NetTC administrator 250 receives, at act 920, the user-level provisioning policy specification, it stores, at act 930, the specified initial QoS policy in the policy server 290. Based on the initial QoS policy, the NetTC administrator 250 constructs, at act 940, the corresponding filter and flow specification. The constructed filter and flow specification are then sent, at act 950, to a NetTC agent that is responsible to enforce flow control on the data flows generated by the application. The NetTC agent must be installed and running on the client where the application is installed.

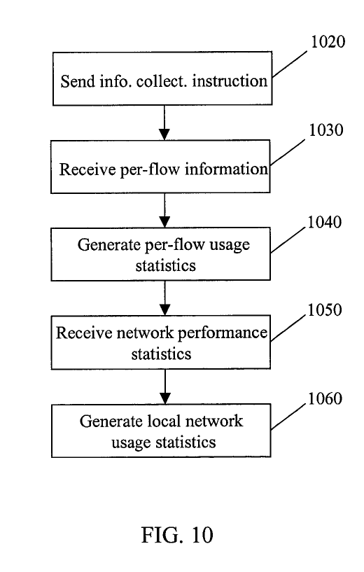

FIG. 10 is a flowchart for a process, in which the NetTC administrator 250 continuously gathers feedback observations about the operational status of the host system 110 and derives useful statistics. In FIG. 10, information collection instructions 670a is first sent at act 1020 from the NetTC administrator 250. Such instructions may be sent to various NetTC agents to instruct what per flow information is to be collected. Such instructions may also be sent (not shown) to the network performance statistics collector 310 to instruct what network performance statistics are to be collected.

The information collection (e.g., per flow information collection and network performance statistics collection) may be performed in either a synchronous or an asynchronous fashion. For example, per flow information collected from different flows may be collected asynchronously. The information collection may also be performed regularly according to some time interval. For example, the network performance statistics may be collected periodically according to a timer with a certain periodicity.

When different types of information are collected as instructed, they are sent to the NetTC administrator 250. In FIG. 10, per flow information sent from various NetTC agents are received at act 1030. Based on the received per flow information, different per flow usage statistics are generated, at act 1040, by the per flow usage analysis unit 820. At the same time, network performance statistics, sent from the network performance statistics collector 310, are received at act 1050. Using the network performance statistics observed across the entire host system 110, the local network usage information analysis unit 830 generates local network usage statistics at act 1060. The process may be repeated and the statistics may be computed incrementally.

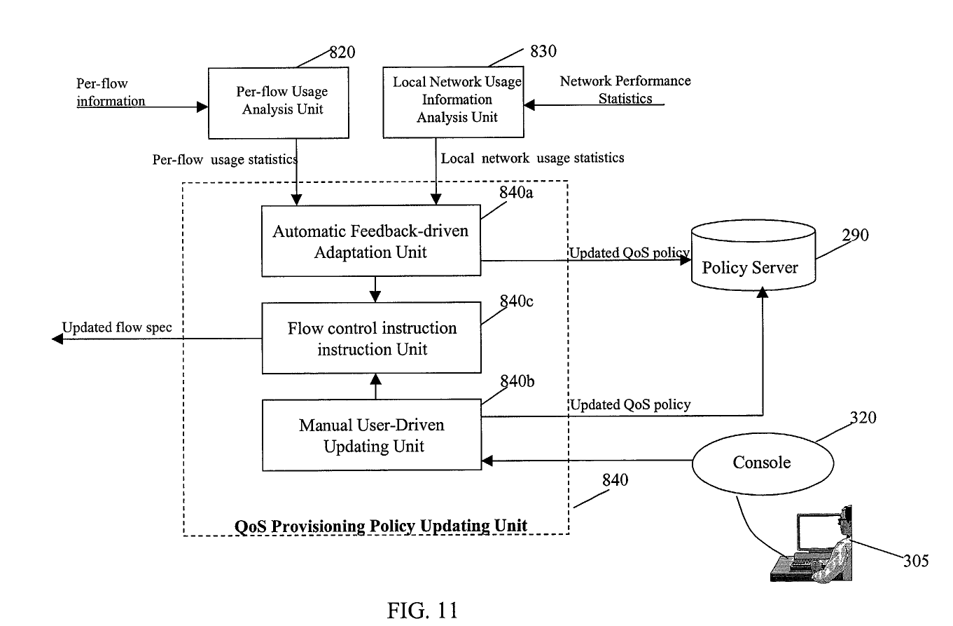

The QoS provisioning policy updating unit 840 may utilize the statistics computed by both the per-flow usage analysis unit 820 and the local network usage information analysis unit 830. One embodiment of the QoS provisioning policy updating unit 840 is illustrated in FIG. 11, where the QoS provisioning policy updating unit 840 comprises an automatic feedback-driven adaptation unit 840a, a manual user-driven updating unit 840b, and a flow control instruction unit 840c.

The manual user-driven updating unit 840b may facilitate, together with the console 320, the requirement for the human administrator 305 to manually update the QoS policies stored in the policy server 290. It may display relevant statistics, based (made by the human administrator 305) on console 320 requests. Such statistics (e.g., local network usage statistics) may provide a basis for the human administrator 305 to decide how to update the QoS policies. The human administrator 305 may provide, through the console 320, update measures which may specify the QoS policies that are to be updated in a certain manner. Based on such update measures, new QoS policies are generated and sent to the policy server 290. Meanwhile, each updated QoS policy may also be sent to the flow control instruction unit 840c so that a corresponding update flow specification may be constructed and sent to the underlying NetTC agent to update the original flow specification constructed based on the original QoS policy.

The automatic feedback-driven adaptation unit 840a enables the NetTC administrator 250 to automatically adjust or adapt QoS policies according to the system feedback statistics, for example, such as statistics that reflect the operational status of the host system 110. In the illustrated embodiment shown in FIG. 11, the automatic feedback-driven adaptation unit 840a determines adaptation measures (or adjustments) based on both the per flow usage statistics (from the per flow usage analysis unit 820) and the local network usage statistics (from the local network information analysis unit 830). The mapping from the statistics to the adaptation measures may be performed based on some optimal criteria. The adaptation measures may specify the QoS policies to be adjusted and the specific adjustments to be made. The adaptation measures are used to revise the QoS policies. The criteria used to automatically determine adaptation measures may be expressed as rules and expressed as conditional statements. For example,

IF (Total BestEffort usage threshold counts exceeded) THEN

(for all BestEffort flows

Reduce TokenRate by “10%”, and

Reduce PeakBandwidth by “25%”)

)

ENDIF

In the above example, the condition expressed in the IF clause (“BestEffort threshold counts exceeded”) specifies when QoS policy adaptation is needed. Such condition may be defined according to some statistics or measurements made from the operational status of the local network supporting the host system 110. In the above example, per flow information may indicate that BestEffort threshold counts are violated. In this case, the adaptation (the actions taken in the THEN clause) may be triggered.

In the above example, the adaptation actions described in the THEN clause include reducing the TokenRate by 10% and reducing the PeakBandwidth by 25%. Both the TokenRate and the PeakBandwidth are specifications through which certain QoS policies may be defined. By changing the values of such specifications, the corresponding QoS policies are revised. Together with the amount of change (e.g., 25% and 10%), the actions described in the THEN clause in the above example specify the adaptation measures, including both the QoS policies to be adjusted (TokenRate and PeakBandwidth) and the amount of the adjustment (10% and 25%). Such adaptation measures are used to automate QoS policy updates.

An updated QoS policy is sent to the policy server 290 to update the existing QoS policy and to the flow control instruction unit 840c to generate corresponding updated flow specification. Similarly, the updated flow specification is then sent to the underlying NetTC agent so that the updated QoS policy can be enforced.

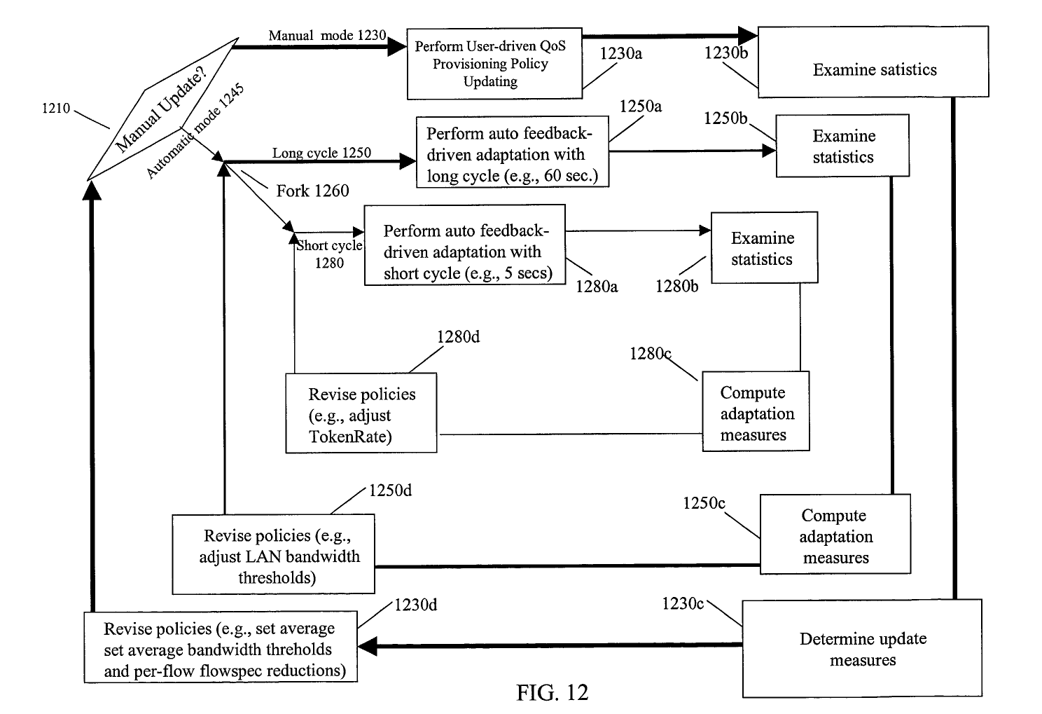

The automatic provisioning policy updating unit 840a may perform automated adaptation on a regular basis. For example, it may perform every 60 seconds. The cycle for the automated QoS policy adaptation may be determined according to the nature of the underlying applications. For example, due to the real time nature of a video conferencing application, the automatic QoS policy adaptation may be performed every 5 seconds. It may also be possible to employ different cycles simultaneously. That is, different threads of automatic QoS policy adaptation may be carried out concurrently and independently. FIG. 12 shows an exemplary schematic flow where three (may be concurrent) different cycles of QoS policy updating may be executed.

In the schematic flow shown in FIG. 12, there comprises one outer most loop (corresponding to manual mode 1230) for the manual user-driven QoS policy updating, and two inner loops (corresponding to a longer cycle 1250 and a short cycle 1280) for the automatic feedback-driven QoS policy adaptation. Within the manual model 1230, user-driven QoS policy updating is performed through 1230b, 1230c, and 1230d. Certain statistics may be requested and reviewed (1230b) before update measures are determined (1230c). Once the update measures are entered or specified, corresponding QoS policies are revised (1230d).

In the automatic mode 1245, two cycles are forked at point 1260. The QoS provisioning policy adaptation in the longer cycle 1250 and in the shorter cycle 1280 may perform policy adaptation with different periodicity. For example, the longer cycle 1250 may correspond to a 60 seconds cycle and the shorter cycle 1280 may correspond to a 5 seconds cycle. In different cycles, the adaptation may be performed in a similar fashion. For example, statistics (both per flow usage statistics and local network usage statistics) are examined (1250b and 1280b) before adaptation measures can be automatically determined (1250c and 1280c). Based on adaptation measures, QoS policies are revised accordingly (1250dand 1280d). A new cycle may then repeated according to the underlying cycle.

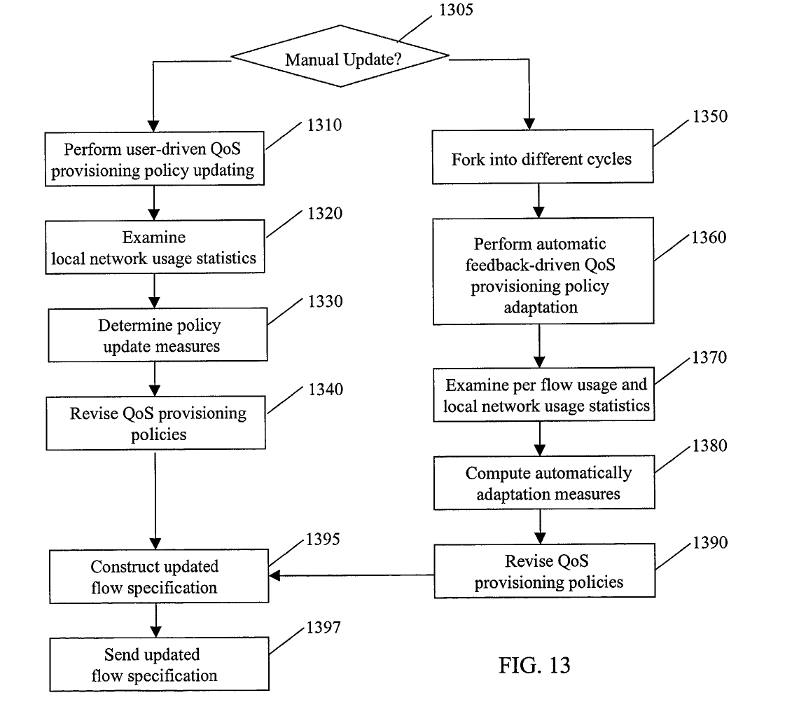

FIG. 13 is a flowchart for the QoS provisioning policy updating unit 840. The mode of the operation (manual or automatic) is determined at act 1305. A manual mode may be activated by the human administrator 305 via the console 320. In the manual mode, user-driven QoS provisioning policy updating is performed. Statistics (e.g., local network usage statistics) that reflect the network status on the host system 110 may be examined at act 1320. Policy update measures are then determined at act 1330 based on the performance statistics. The update measures determined at act 1330 may include both what QoS policies are to be updated and how each is to be updated. Such information is then used at act 1340 to revise the QoS policies.

When the QoS provisioning policy updating unit 840 is operating in an automatic mode (which may be concurrent with the manual mode), it may operate simultaneously in several threads, each with a different cycle. In this case, different cycles are forked at act 1350 and each performing QoS policy adaptation at act 1360 independently. In each cycle, both per flow usage statistics and local network usage statistics may be examined at act 1370. Adaptation measures are automatically computed at act 1380 and used to revised corresponding QoS policies at act 1390.

The updating of QoS policies triggers the reconstruction of the corresponding flow specifications at act 1395 to generate updated flow specifications. The updated flow specifications are then sent, at act 1397, to relevant NetTC agents.

The processing described above may be performed by a general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A system for host-based QoS privisioning, comprising:
a host system connecting to a network, said host system initiating data flows that are sent to said network; and
a centralized QoS privisioning mechanism for enforcing flow control applied on said data flows originated from said host system, said centralized QoS provisioning mechanism connecting to said host system.

2. The system according to claim 1, wherein said host system comprises:
a server; and
at least one client capable of communicating with said server.

3. The system according to claim 2, wherein said centralized QoS provisioning mechanism comprises:
at least one network traffic control agent that are responsible for enforcing said flow control, each of said at least one network traffic control agent running on one of said at least one client, imposing said flow control on data flows initiated by applications runing on said one of said at least one client;
a network traffic control administrator, running on said server, for conducting centralized QoS provisioning and for performing said centralized QoS provisioning by enforcing flow control via said at least one network traffic control agent; and
a policy server for storing said QoS provisioning policy.

4. The system according to claim 3, further comprising:
a console for performing user-level QoS provisioning; and
a network performance statistics collector for collecting network performance statistics from said host system, said network performance statistics being utilized by said network traffic control administrator to perform automatic feedback-driven QoS provisioning policy adaptation.

5. A system for a network traffic control agent, comprising:
a communication unit for interacting with a network traffic control administrator wherein said network traffic control administrator is running on a server in a host system comprising said server and at least one client;
a filtering unit for filtering an application based on a filter received from said network traffic control administrator via said communication unit, said application running on one of said at least one client in said host system, said network traffic control agent running on said one of said at least one client; and
a flow control enforcement unit for enforcing flow control on data flows generated by said application according to a flow specification received from said network traffic control administrator via said communication unit.

6. The system according to claim 5, further comprising:
a storage for storing said flow specification received from said network traffic control administrator; and
a flow monitoring unit for collecting per flow information from said data flows of said application and sending said per flow information to said network traffic control administrator via said communication unit.

7. A system for a network traffic control administrator, comprising:
a communication unit for communicating with at least one network traffic control agent;
a per-flow usage analysis unit for analyzing per-flow information collected by said at least one network traffic control agent and received via said communication unit, to generate per-flow usage statistics;
a local network usage information analysis unit for analyzing the network performance statistics to generate local network usage statistics;
a QoS provisioning unit for conducting centralized QoS provisioning to generate QoS provisioning policy and for updating said QoS provisioning policy based on said per-flow usage statistics and said local network usage statistics; and
a flow control instruction unit for constructing a filter and a flow specification based on said QoS provisioning policy, said filter and said flow specification being sent, via said communication unit, to said at least one network traffic control agent to enforce flow control; and
a QoS provisioning policy updating unit for updating QoS provisioning policies.

8. The system according to claim 7, wherein said QoS provisioning policy updating unit comprises:
a manual user-driven updating unit for performing manual update of said QoS provisioning policy to generate updated QoS policy;
an automatic feedback-driven adaptation unit for dynamically adjusting said QoS provisioning policy based on said local network usage statistics and said per-flow usage statistics to generate updated QoS policy; and
a flow control instruction unit for constructing updated flow specifications based on said updated QoS policy.

9. A method for host-based QoS provisioning, comprising:
performing, by a network traffic control administrator, centralized QoS provisioning for an application to generate QoS provisioning policy, stored on a policy server, said application running in a host system;
constructing, by said network traffic control administrator, a filter and a flow specification according to said QoS provisiong policy, said filter and said flow specification being used to enforce flow control on data flows initiated from said application;
sending said filter and said flow specification to a network traffic control agent;
receiving, by said network traffic control agent, said filter and said flow specification;
filtering, by said network traffic control agent, said application using said filter; and
enforcing said flow control, based on said flow specification, on said data flows of said application.

10. The method according to claim 9, further comprising:
activating, by said network traffic control administrator, a QoS provisioning policy updating unit;
examining statistics relevant to the operational status of said host system;
generating an updated QoS provisioning policy based on said statistics, said updated QoS provisioning policy being stored in said policy server;
constructing an updated flow specification according to said updated QoS provisioning policy; and
sending said updated flow specification to said network traffic control agent.

11. The method according to claim 10, wherein said statistics includes at least one of:
per-flow usage statistics derived based on per flow information collected by at least one network traffic control agent; and
local network usage statistics derived based on network performance statistics collected by a network performance statistics collector.

12. A method for a network traffic control agent, comprising:
receiving a filter and a flow specification from a network traffic control administrator, said filter and said flow specification being associated with an application;
filtering said application running on a client on which said network traffic control agent resides, said application initiating data flows;
retrieving a flow specification associated with said application; and
enforcing flow control on said data flows based on said flow specification.

13. The method according to claim 12, further comprising:
receiving information collection instruction from said network traffic control administrator;
monitoring said data flows initiated from said application to collect per-flow information specified in said information collection instruction; and
sending said per-flow information to said network traffic control administrator.

14. A method for a network traffic control administrator, comprising:
receiving a request for centralized QoS provisioning associated with an application, said application being installed on a client where a network traffic control agent resides;
receiving a user-level provisioning specification corresponding to QoS provisioning policy associated with said application; and
storing said QoS provisioning policy associated with said application in a policy server;
constructing a filter associated with said application;
constructing a flow specification corresponding to said QoS provisioning policy associated with said application; and
sending said filter and said flow specification to said network traffic control agent.

15. The method according to claim 14, further comprising:
receiving per-flow information from at least one network traffic control agent;
generating per-flow usage statistics by analyzing said per-flow information received from said at least one network traffic control agent;
receiving network performance statistics from a network performance statistics collector; and
generating local network usage statistics by analyzing said network performance statistics received from said network performance statistics collector.

16. The method according to claim 15, further comprising updating QoS provisioning policy.

17. The method according to claim 16, wherein said updating comprises:
determining whether said updating is to be performed in manual user-driven mode or in automatic feedback-driven mode;
performing manual user-driven QoS provisioning policy updating if said updating is to be performed in said manul user-driven mode, determined by said determining; and
performing automatic feedback-driven QoS provisioning policy adaptation if said updating is to be performed in said automatic feedback-driven mode, determined by said determining.

18. The method according to claim 17, wherein said performing manual user-driven QoS provisioning policy updating comprises:
examining said per-flow usage statistics and said local network usage statistics;
determining policy update measures based on said per-flow usage statistics and said local network usage statistics; and
revising said QoS provisioning policy stored in said policy server according to said policy update measures.

19. The method according to claim 17, wherein said performing automatic feedback-driven QoS provisioning policy adaptation comprises:
forking into a plurality of cycles, said automatic feedback-driven QoS provisioning adaptation is performed in each of said plurality of cycles based on a different cycle length;
examining, in each of said plurality of cycles, said per flow usage statistics and said local network usage statistics;
computing automatically, in each of said plurality of cycles, adaptation measures to be applied to said QoS provisioning policy based on said per flow usage statistics and said local network usage statistics;
revising, in each of said plurality of cycles, said QoS provisioning policy stored in said policy server according to said adaptation measures.

20. A computer-readable medium encoded with a program for host-based QoS provisioning, said program comprising:
performing, by a network traffic control administrator, centralized QoS provisioning for an application to generate QoS provisioning policy, stored on a policy server, said application running in a host system;
constructing, by said network traffic control administrator, a filter and a flow specification according to said QoS provisiong policy, said filter and said flow specification being used to enforce flow control on data flows initiated from said application;
sending said filter and said flow specification to a network traffic control agent;
receiving, by said network traffic control agent, said filter and said flow specification;
filtering, by said network traffic control agent, said application using said filter; and
enforcing said flow control, based on said flow specification, on said data flows of said application.

21. The medium according to claim 20, said program further comprising:
activating, by said network traffic control administrator, a QoS provisioning policy updating unit;
examining statistics relevant to the operational status of said host system;
generating an updated QoS provisioning policy based on said statistics, said updated QoS provisioning policy being stored in said policy server;
constructing an updated flow specification according to said updated QoS provisioning policy; and
sending said updated flow specification to said network traffic control agent.

22. A computer-readable medium encoded with a program for a network traffic control agent, said program comprising:
receiving a filter and a flow specification from a network traffic control administrator, said filter and said flow specification being associated with an application;
filtering said application running on a client on which said network traffic control agent resides, said application initiating data flows;
retrieving a flow specification associated with said application; and
enforcing flow control on said data flows based on said flow specification.

23. The medium according to claim 22, said program further comprising:
receiving information collection instruction from said network traffic control administrator;
monitoring said data flows initiated from said application to collect per-flow information specified in said information collection instruction; and
sending said per-flow information to said network traffic control administrator.

24. A computer-readable medium encoded with a program for a network traffic control administrator, said program comprising:
receiving a request for centralized QoS provisioning associated with an application, said application being installed on a client where a network traffic control agent resides;
receiving a user-level provisioning specification corresponding to QoS provisioning policy associated with said application; and
storing said QoS provisioning policy associated with said application in a policy server;
constructing a filter associated with said application;
constructing a flow specification corresponding to said QoS provisioning policy associated with said application; and
sending said filter and said flow specification to said network traffic control agent.

25. The medium according to claim 24, said program further comprising:
receiving per-flow information from at least one network traffic control agent;
generating per-flow usage statistics by analyzing said per-flow information received from said at least one network traffic control agent;
receiving network performance statistics from a network performance statistics collector; and
generating local network usage statistics by analyzing said network performance statistics received from said network performance statistics collector.

26. The medium according to claim 25, said program further comprising updating QoS provisioning policy.

27. The medium according to claim 26, wherein said updating comprises:
determining whether said updating is to be performed in manual user-driven mode or in automatic feedback-driven mode;
performing manual user-driven QoS provisioning policy updating if said updating is to be performed in said manual, user-driven mode, determined by said determining; and
performing automatic feedback-driven QoS provisioning policy adaptation if said updating is to be performed in said automatic feedback-driven mode, determined by said determining.

28. The medium according to claim 27, wherein said performing manual user-driven QoS provisioning policy updating comprises:
examining said per-flow usage statistics and said local network usage statistics;
determining policy update measures based on said per-flow usage statistics and said local network usage statistics; and
revising said QoS provisioning policy stored in said policy server according to said policy update measures.

29. The medium according to claim 27, wherein said performing automatic feedback-driven QoS provisioning policy adaptation comprises:
forking into a plurality of cycles, said automatic feedback-driven QoS provisioning adaptation is performed in each of said plurality of cycles based on a different cycle length;
examining, in each of said plurality of cycles, said per flow usage statistics and said local network usage statistics;
computing automatically, in each of said plurality of cycles, adaptation measures to be applied to said QoS provisioning policy based on said per flow usage statistics and said local network usage statistics;
revising, in each of said plurality of cycles, said QoS provisioning policy stored in said policy server according to said adaptation measures.
